(19) United States
(12) Patent Application Publication
(10) Pub. No.: US 2009/0303695 A1
(43) Pub. Date: Dec. 10, 2009

(54) Display Element for an Electric Appliance

(75) Inventors: Martin Buchstab, Bopfingen (DE); Irene Dumkow, Sontheim (DE); Adolf Feinauer, Giengen (DE); Klaus Flinner, Zoschingen (DE); Bernd Heger, Haunsheim (DE); Peter Nalbach, Kirchheim/Nabern (DE); Kasim Yazan, Ulm (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgerate GmbH, Munchen (DE)

(21) Appl. No.: 12/085,818

(22) PCT Filed: Oct. 24, 2006
(86) PCT No.: PCT/EP2006/067705

§ 371 Date: May 28, 2008

(30) Foreign Application Priority Data
Nov. 30, 2005 (DE) 102005057166.2

(51) Int. Cl. G09F 13/04

(52) U.S. Cl. 362/97.1

(57) ABSTRACT

A display element comprising a light-emitting diode and a display field that is backlit by the light-emitting diode. In said element, the beam path of the light in the display element passes through at least two light scattering elements.

The present invention relates to a display element by way of a luminous display in an electric appliance, in particular a domestic appliance such as a refrigerator or freezer.

Light-emitting diodes have been used in small luminous displays for some time. Over the last few years, extremely light-intensive light-emitting diodes have come increasingly onto the market in all colors of the spectrum. One problem with these light-emitting diodes, in particular the white and blue light-emitting diodes, is that they emit a significantly bundled beam, which is perceived to be dazzling if it strikes the eye directly. If such light-emitting diodes are to be used for a luminous display, care must be taken to ensure that a direct gaze onto the light-emitting diode is not possible. As a result of the significant bundling, such a light-emitting diode, if attached to a backlit display field, is only able to illuminate a small surface of this display field, which is however very glaring. The further the light-emitting diode is from the display field however, the more bulky the overall display element and the smaller the angular range from which the display is clearly visible.

The object of the present invention is to specify a display element with a light-emitting diode, which is designed in a simple and compact fashion and can be easily read from a large angular range.

To this purpose, at least two light-scattering elements are arranged in the beam path between the light-emitting diode and the display field which is backlit thereby. The first of these is used to expand the bundled beam of the light-emitting diode, so that this illuminates the element scattering the second light over a large surface. The display element is easily visible to any observer, for whom the display field and the illuminated second scattering element are disposed on a line. At least one of the light-scattering elements disposed at the second site in the beam path is preferably a diffusing screen. This can be realized in a simple fashion as a coat of paint applied to the display field itself.

The light-scattering element adjacent to the light-emitting diode is preferably a lens. A cylindrical lens is preferably used in order to illuminate a display field with a height/width ratio which deviates from 1. A display field which is wider than it is high is well suited to displaying short texts or individual words.

The beam path can be surrounded by reflective side surfaces between the light-scattering elements, in order to prevent light losses at the sides.

Further features and advantages of the invention result from the description which follows of exemplary embodiments with reference to the appended figures, in which;

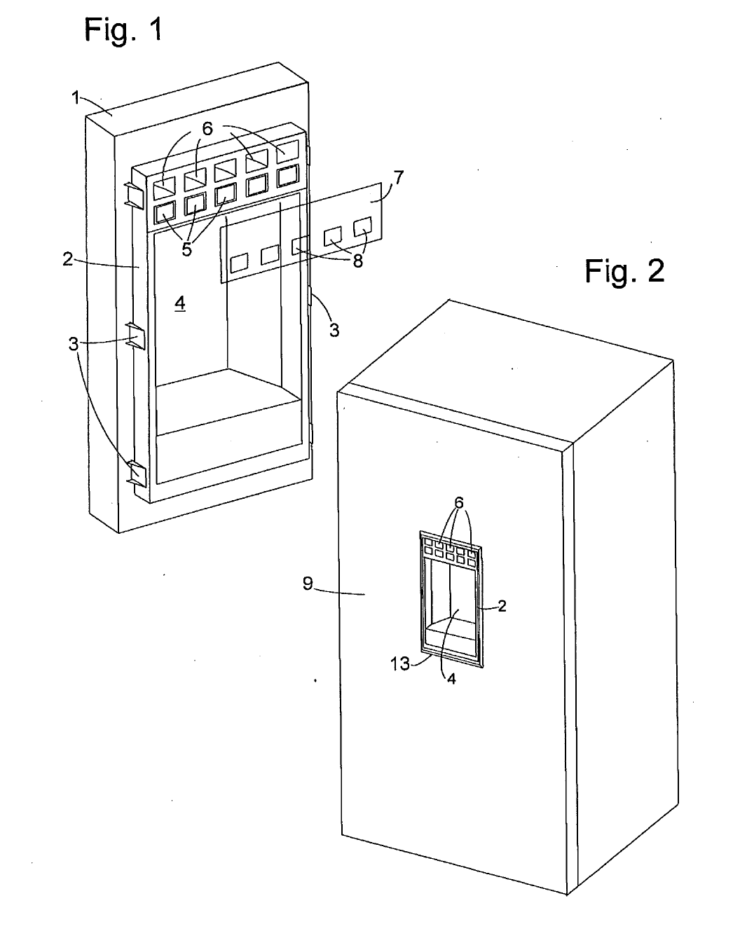

FIG. 1 shows a schematic perspective view of a water dispenser for integration into a refrigerator, which is provided with display elements according to the invention;

FIG. 2 shows a view of the refrigerator with an integrated water dispenser;

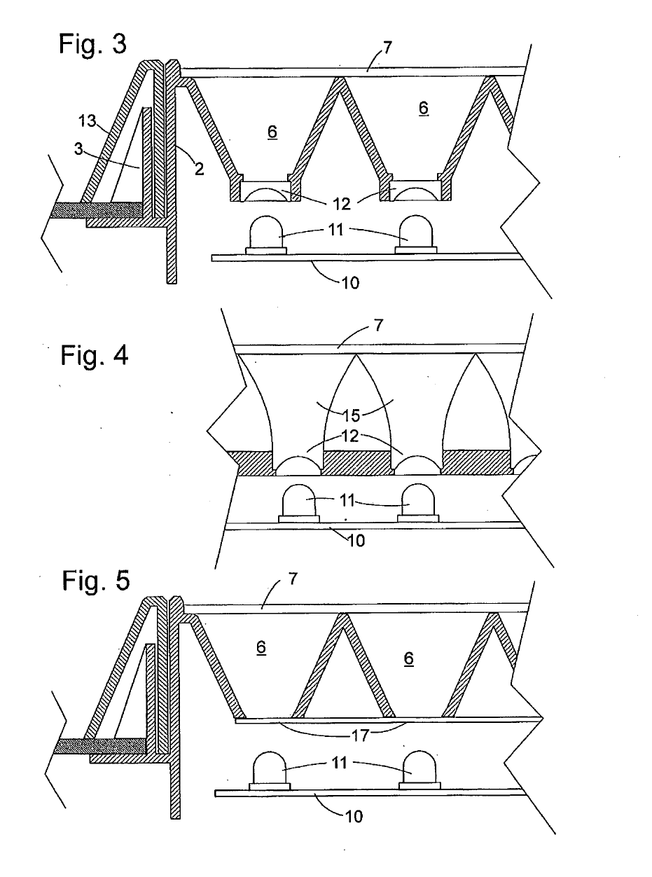

FIG. 3 shows a horizontal section through display elements of the water dispenser according to a first embodiment;

FIG. 4 shows a section similar to FIG. 3 in accordance with a second embodiment and;

FIG. 5 shows a section similar to FIG. 3 in accordance with a third embodiment.

FIG. 1 shows a plastic housing provided for integration in a refrigerator door and having an essentially cuboid base body 1, which is provided in order to be assembled in the interior of the door, embedded in a layer of insulation material, and having a flat cuboid projection 2, which is provided in order to protrude through a window which is cut out of the outer wall of the door, when in an assembled state. Pins 3 of the projection 2 are used for anchorage to the edges of the window. One outlet for water and/or ice, which is not visible in the Fig., opens out into a central recess 4, in order to fill a container positioned there.

A plurality of operating keys 5 are arranged above the recess 4. Light wells 6 are visible above said operating keys, said light wells 6 belonging to display elements in each instance, which display a state of the water dispenser or ice maker which relates to the actuation of the operating keys 5. A transparent plastic diaphragm 7 which is shown detached in the Fig. covers the light wells 6 when in an assembled state and has a plurality of openings 8, through which the operating keys 5 can be accessed.

For clarification purposes, FIG. 2 shows the water dispenser which is assembled in the door 9 of a refrigerator. A fitted frame 13 surrounds the projection 2 and covers edges of a window which is cut out of the front side of the door 9.

FIG. 3 shows a horizontal partial section through the water dispenser in FIG. 1 in a horizontal plane running through the display elements. Each display element includes a light-emitting diode 11 mounted on a printed circuit board 10 and a dispersing lens 12 held in front thereof in a holder of the base body 1. As the light wells 6, as shown in FIG. 1, are wider than they are high, the lenses 12 are cylindrical or astigmatic, i.e. they have a shorter focal distance in a horizontal section plane than in a vertical section plane.

The dispersing lenses 12 seal one end of the light wells 6 in each instance; the other end is covered by the diaphragm 7. The interior of the diaphragm 7 facing towards the light-emitting diodes 11 is embodied as a diffusing screen, e.g. by means of sandblasting, glued dispersion foil, applied dispersion varnish or suchlike. Lettering to be displayed—in a positive or negative illustration—is likewise attached to the interior of the diaphragm 7. The effect of the dispersing lens 12 causes lettering to be equally illuminated over its entire surface and to be easily read from a large spatial angle by virtue of the diffusing screen on the rear of the diaphragm 7.

FIG. 3 also shows a section of the frame 13, which on the one hand is clamped and held between a lateral edge of the projection 2 and one of the pins 3 and on the other hand rests against the front side of the outer wall 14, thus concealing the edge of the window which is cut out of the door, through which the projection 2 extends.

In the embodiment in FIG. 4, light wells 6 are replaced by crystal clear plastic elements 15 which are in one piece with the dispersing lens 12, said plastic elements 15 guiding light at their lateral walls 16 by means of total reflection to the diaphragm 7.

In the embodiment in FIG. 5, each display element again has a light well 6, but the dispersing lenses 12 are replaced by a second diffusing screen 17, which likewise expands the light beam of the light-emitting diodes 11 striking thereupon. To prevent light losses as a result of light striking the walls of the light wells, these walls are preferably mirrored or at least colored white.

1-7. (canceled)

8. A display element comprising:
a light-emitting diode;
a display field, the light-emitting diode emitting light along a beam path and the light-emitting diode being operable to backlight the display field; and
at least two light-scattering elements, the beam path of light emitted by the light-emitting diode passing through the at least two light-scattering elements.

9. The display element as claimed in claim 8, wherein at least one of the light-scattering elements is a diffusing screen.

10. The display element as claimed in claim 9, wherein the at least one light-scattering element an application of paint applied to the display field.

11. The display element as claimed in claim 8, wherein one of the light-scattering elements is adjacent to the light-emitting diode and is a lens.

12. The display element as claimed in claim 11, wherein the lens is a cylindrical lens.

13. The display element as claimed in claim 8, wherein an extent of the beam path extends between the light-scattering elements and is surrounded by reflective walls.
